(19) United States
(12) Patent Application Publication
(10) Pub. No.: US 2025/0010369 A1
(43) Pub. Date: Jan. 9, 2025

(54) CYLINDRICAL BONDED MAGNET, METHOD OF PRODUCING CYLINDRICAL BONDED MAGNET, AND MOLD FOR FORMING CYLINDRICAL BONDED MAGNET

(71) Applicant: NICHIA CORPORATION, Anan-shi (JP)

(72) Inventors: Rie YOSHIDA, Anan-shi (JP); Daichi ITAMI, Anan-shi (JP); Muneo YAMAMOTO, Tokushima-shi (JP)

(73) Assignee: NICHIA CORPORATION, Anan-shi (JP)

(21) Appl. No.: 18/764,657

(22) Filed: Jul. 5, 2024

(30) Foreign Application Priority Data
Jul. 6, 2023 (JP) 2023-111253

(51) Int. Cl. B22F 3/22; H01F 1/057; H01F 7/02; H01F 41/02

(52) U.S. Cl. CPC B22F 3/225; H01F 1/057; H01F 7/02; H01F 41/0266; B22F 2202/05; B22F 2301/355; B22F 2998/10; B22F 2999/00

(57) ABSTRACT

A method of producing a cylindrical bonded magnet includes providing a mold including an inner mold portion, an outer mold portion, a first orientation magnet, and a second orientation magnet, and performing molding to obtain a cylindrical bonded magnet by filling a region between the outer surface of the inner mold portion and the inner surface of the outer mold portion with a resin composition. When viewed in a cross-section, a first distance is shorter than a second distance, the first distance is a straight line distance along a magnetic field application direction and is tangent to a circle defined by the inner surface of the outer mold portion, and the second distance is a straight line distance along the magnetic field application direction and passes through a center of a circle defined by the outer surface of the inner mold portion.

### CROSS-REFERENCE TO RELATED PATENT APPLICATION

This application claims priority to Japanese Patent Application No. 2023-111253 filed on Jul. 6, 2023. The disclosure of Japanese Patent Application No. 2023-111253 is hereby incorporated by reference in its entirety.

### BACKGROUND

The present disclosure relates to a cylindrical bonded magnet, a method of producing the cylindrical bonded magnet, and a mold for forming the cylindrical bonded magnet.

Known cylindrical magnets include a cylindrical magnet having four magnetic poles with a sine magnetic flux density waveform (Japanese Patent Publication No. 2017-212863); and a cylindrical magnet having two magnetic poles with a magnetic flux density waveform close to a triangular waveform (Japanese Patent Publication No. 2019-123126). However, particularly when it is desired to produce a two-pole sine waveform cylindrical magnet, since the waveform of the magnetic field during the magnetic field orientation is different from the magnetic flux density waveform of the actually produced magnet, it is difficult for both the methods described in Japanese Patent Publication No. 2017-212863 and Japanese Patent Publication No. 2019-123126 to produce a cylindrical magnet having a magnetic flux density waveform close to a sine waveform.

### SUMMARY

Certain embodiments of the present disclosure aim to provide a cylindrical bonded magnet having a sine magnetic flux density waveform or a magnetic flux density waveform close to a sine waveform, a method of producing the cylindrical bonded magnet, and a mold for forming the cylindrical bonded magnet.

Exemplary embodiments of the present disclosure relate to a method of producing a cylindrical bonded magnet, the method including:
providing a mold including an inner mold portion including a non-magnetic component, an outer mold portion including a non-magnetic component, a first orientation magnet, and a second orientation magnet,
the inner mold portion having an outer surface that forms a circle when viewed in a cross-section taken in a direction,
the outer mold portion having an inner surface that is spaced from the outer surface of the inner mold portion and forms a circle when viewed in said cross-section taken in said direction,
the first orientation magnet and the second orientation magnet being located to sandwich the inner mold portion and the outer mold portion in said direction; and
performing molding to obtain a cylindrical bonded magnet by filling a region between the outer surface of the inner mold portion and the inner surface of the outer mold portion with a resin composition and molding the resin composition, while applying a magnetic field using the first orientation magnet and the second orientation magnet.

When viewed in said cross-section taken in said direction, a first distance is shorter than a second distance, the first distance is a straight line distance along a magnetic field application direction between the first orientation magnet and the second orientation magnet and is tangent to the circle defined by the inner surface of the outer mold portion, and the second distance is a straight line distance along the magnetic field application direction between the first orientation magnet and the second orientation magnet and passes through a center of the circle defined by the outer surface of the inner mold portion.

Exemplary embodiments of the present disclosure relate to a cylindrical bonded magnet, including an anisotropic rare earth magnetic powder and a resin, having two poles oriented in a radial direction, and having a distortion factor with respect to a sine curve of a surface magnetic flux density on an outer peripheral side that is not higher than 15%.

Exemplary embodiments of the present disclosure relate to a mold for forming a cylindrical bonded magnet, including an inner mold portion including a non-magnetic component, an outer mold portion including a non-magnetic component, a first orientation magnet, and a second orientation magnet. The inner mold portion having an outer surface that forms a circle when viewed in a cross-section taken in a direction. The outer mold portion having an inner surface that is spaced from the outer surface of the inner mold portion and forms a circle when viewed in said cross-section taken in said direction. The first orientation magnet and the second orientation magnet being located to sandwich the inner mold portion and the outer mold portion so that a magnetic field is applied in said direction during magnetic field orientation. When viewed in said cross-section taken in said direction, a first distance is shorter than a second distance. The first distance is a straight line distance along a magnetic field application direction between the first orientation magnet and the second orientation magnet and is tangent to the circle defined by the inner surface of the outer mold portion. The second distance is a straight line distance along the magnetic field application direction between the first orientation magnet and the second orientation magnet and passes through a center of the circle defined by the outer surface of the inner mold portion.

The method of producing a cylindrical bonded magnet and the mold for forming a cylindrical bonded magnet according to the embodiments of the disclosure can provide a cylindrical bonded magnet having a sine magnetic flux density waveform or a magnetic flux density waveform close to a sine waveform.

### BRIEF DESCRIPTION OF DRAWINGS

FIG. 1A shows a cross-sectional view of a mold for forming a cylindrical bonded magnet used in Example 1.

FIG. 1B shows a graph of the surface magnetic flux density of the outer periphery of a cylindrical bonded magnet produced in Example 1 plotted against angle.

FIG. 1C shows an image illustrating the magnetization directions in specific regions of the cylindrical bonded magnet of Example 1.

FIG. 1D shows a cross-sectional view of the mold for forming a cylindrical bonded magnet used in Example 1 which is open upon releasing a molded product.

FIG. 2A shows a graph of the orientation field plotted against angle in Example 2.

FIG. 2B shows a graph of the surface magnetic flux density of the outer periphery of a cylindrical bonded magnet produced in Example 2 plotted against angle.

FIG. 3A shows a cross-sectional view of a mold for forming a cylindrical bonded magnet used in Example 3.

FIG. 3B shows a graph of the orientation field plotted against angle in Example 3.

FIG. 3C shows a graph of the surface magnetic flux density of the outer periphery of a cylindrical bonded magnet produced in Example 3 plotted against angle.

FIG. 4A shows a cross-sectional view of a mold for forming a cylindrical bonded magnet used in Example 4.

FIG. 4B shows a graph of the orientation field plotted against angle in Example 4.

FIG. 4C shows a graph of the surface magnetic flux density of the outer periphery of a cylindrical bonded magnet produced in Example 4 plotted against angle.

FIG. 4D shows a cross-sectional view of the mold for forming a cylindrical bonded magnet used in Example 4 which is open upon releasing a molded product.

FIG. 5A shows a cross-sectional view of a mold for forming a cylindrical bonded magnet used in Example 5.

FIG. 5B shows a graph of the orientation field plotted against angle in Example 5.

FIG. 5C shows a graph of the surface magnetic flux density of the outer periphery of a cylindrical bonded magnet produced in Example 5 plotted against angle.

FIG. 6A shows a cross-sectional view of a mold for forming a cylindrical bonded magnet used in Example 6.

FIG. 6B shows a graph of the orientation field plotted against angle in Example 6.

FIG. 6C shows a graph of the surface magnetic flux density of the outer periphery of a cylindrical bonded magnet produced in Example 6 plotted against angle.

FIG. 7A shows a cross-sectional view of a mold for forming a cylindrical bonded magnet used in Comparative Example 1.

FIG. 7B shows a graph of the surface magnetic flux density of the outer periphery of a cylindrical bonded magnet produced in Comparative Example 1 plotted against angle.

FIG. 7C shows an image illustrating the magnetization directions in specific regions of the cylindrical bonded magnet of Comparative Example 1. The parts enclosed by squares correspond to the parts indicated by arrows in FIG. 7B.

FIG. 8A shows a graph of the orientation field plotted against angle in Comparative Example 2.

FIG. 8B shows a graph of the surface magnetic flux density of the outer periphery of a cylindrical bonded magnet produced in Comparative Example 2 plotted against angle.

FIG. 9A shows a cross-sectional view of a mold for forming a cylindrical bonded magnet used in Comparative Example 3.

FIG. 9B shows a graph of the orientation field plotted against angle in Comparative Example 3.

FIG. 9C shows a graph of the surface magnetic flux density of the outer periphery of a cylindrical bonded magnet produced in Comparative Example 3 plotted against angle.

### DETAILED DESCRIPTION

Embodiments of the present disclosure are described in detail below. The following embodiments, however, are intended as examples to embody the technical idea of the present disclosure and are not intended to limit the scope of the present disclosure to the following embodiments. As used herein, the term “process” encompasses not only an independent process but also a process that may not be clearly distinguished from other processes, as long as a desired object of the process is achieved. Moreover, numerical ranges indicated using “to” refer to ranges including the numerical values before and after “to” as the minimum and maximum, respectively.

### Mold for Forming Cylindrical Bonded Magnet

A mold for forming a cylindrical bonded magnet according to embodiments of the present disclosure includes an inner mold portion including a non-magnetic component, an outer mold portion including a non-magnetic component, a first orientation magnet, and a second orientation magnet. The inner mold portion has an outer surface that forms a circle when viewed in a cross-section taken in a direction. The outer mold portion has an inner surface that is spaced from the outer surface of the inner mold portion and forms a circle when viewed in the cross-section taken in the direction. The first orientation magnet and the second orientation magnet are located to sandwich the inner mold portion and the outer mold portion so that a magnetic field is applied in the direction during magnetic field orientation. When viewed in the cross-section taken in the direction, a first distance is shorter than a second distance. The first distance is a straight line distance along a magnetic field application direction between the first orientation magnet and the second orientation magnet and is tangent to the circle defined by the inner surface of the outer mold portion. The second distance is a straight line distance along the magnetic field application direction between the first orientation magnet and the second orientation magnet and passes through a center of the circle defined by the outer surface of the inner mold portion.

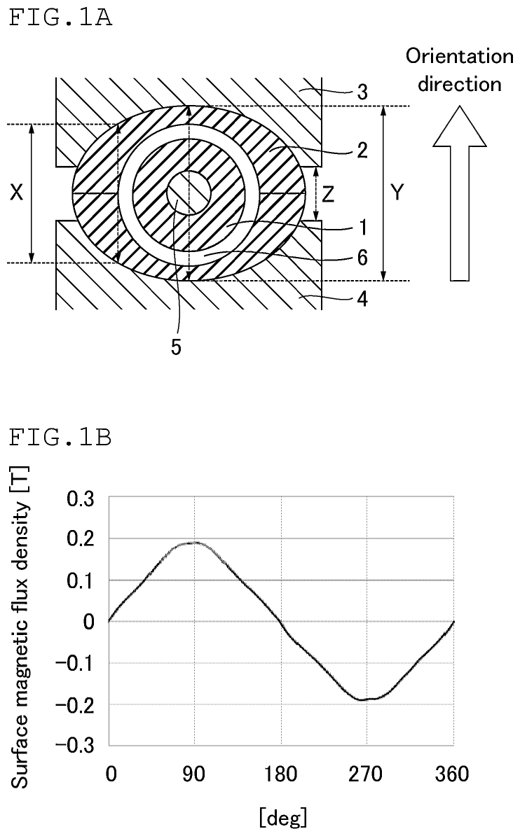

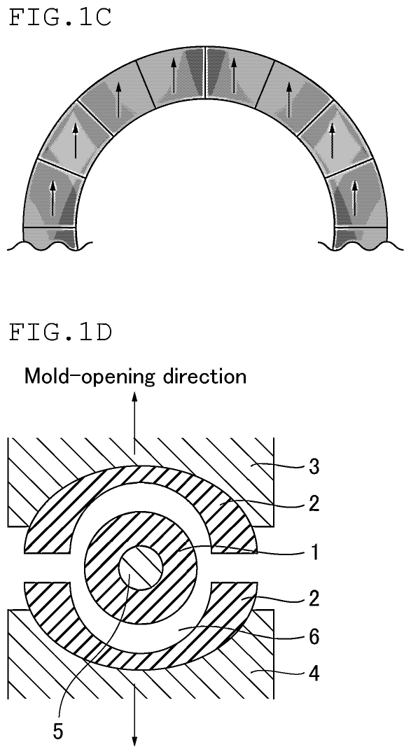

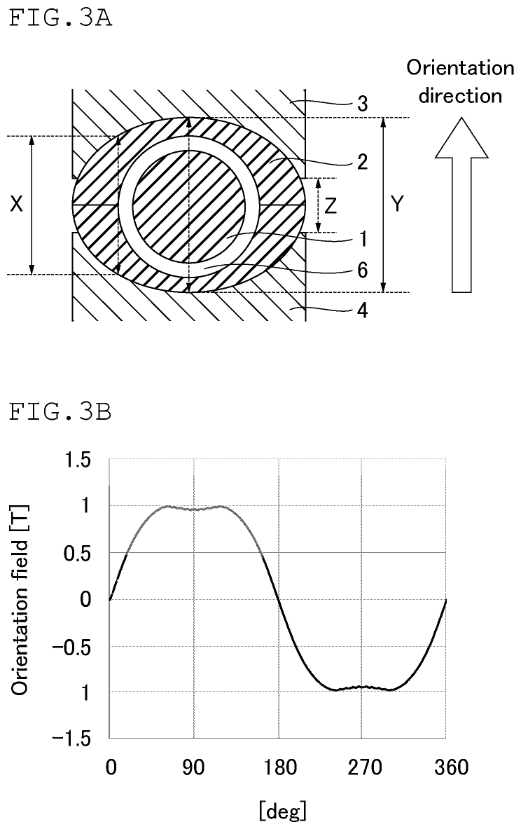

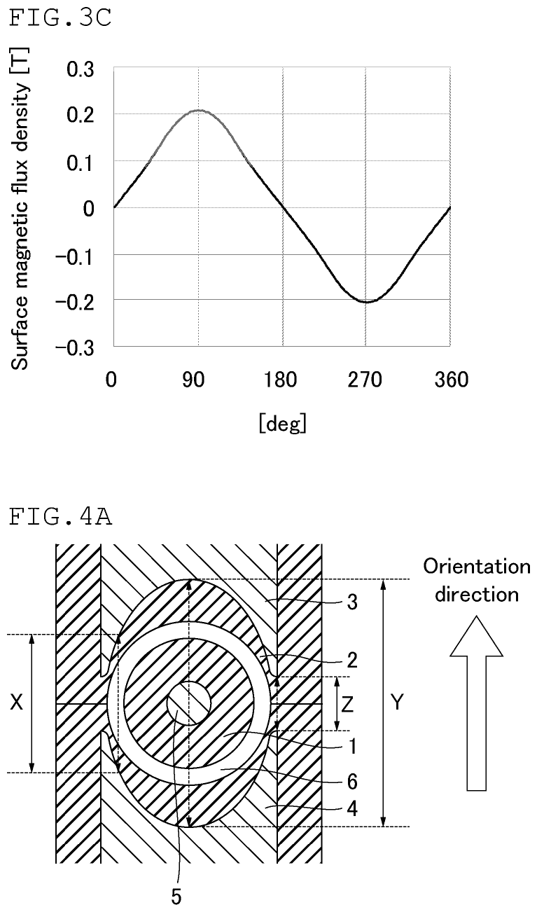

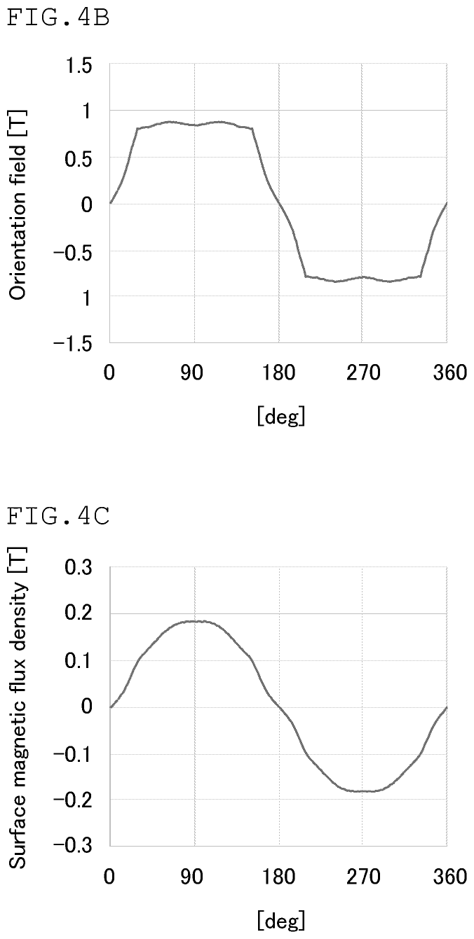

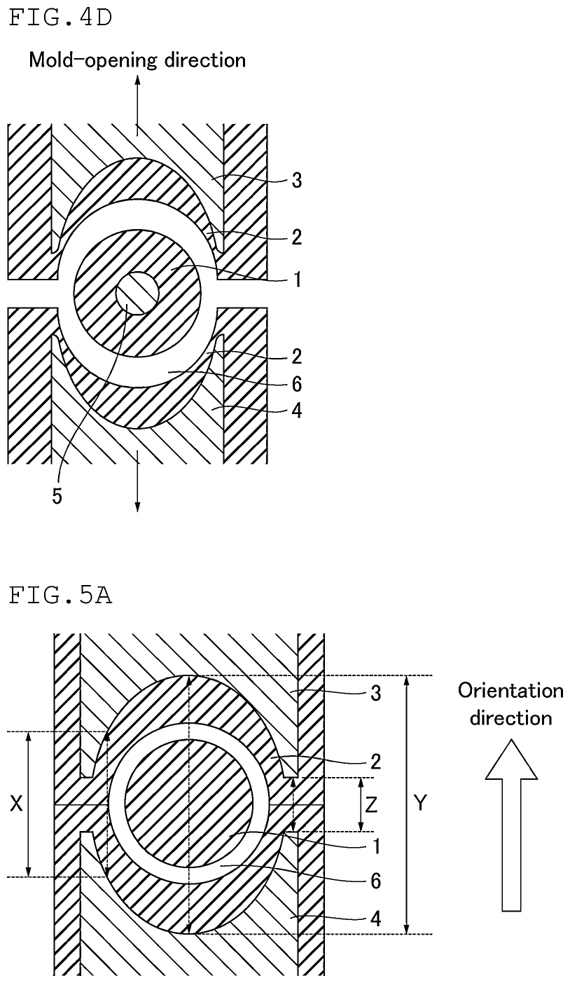

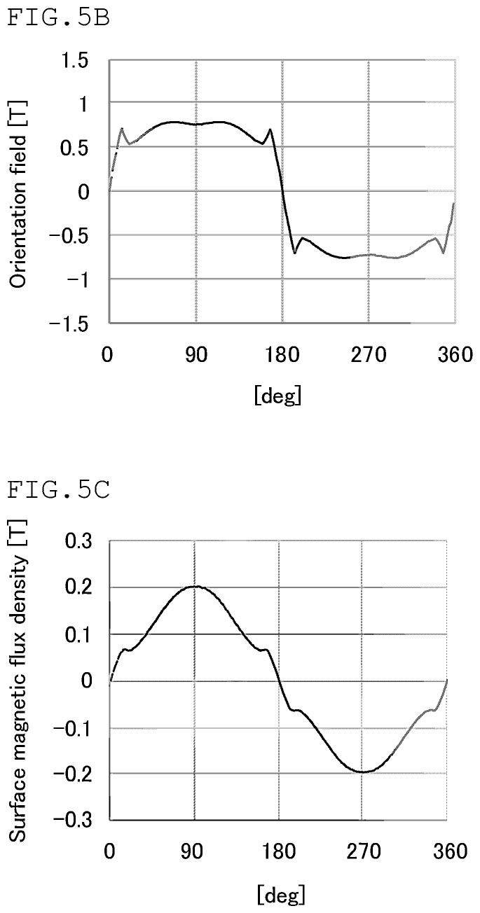

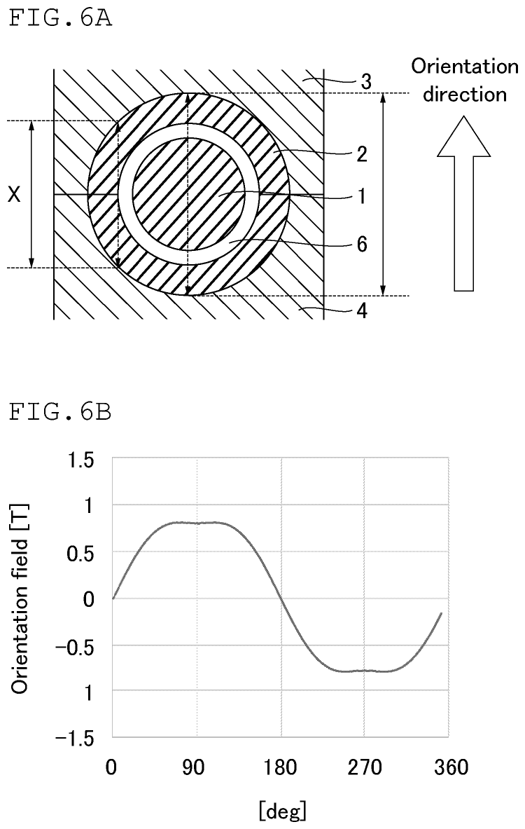

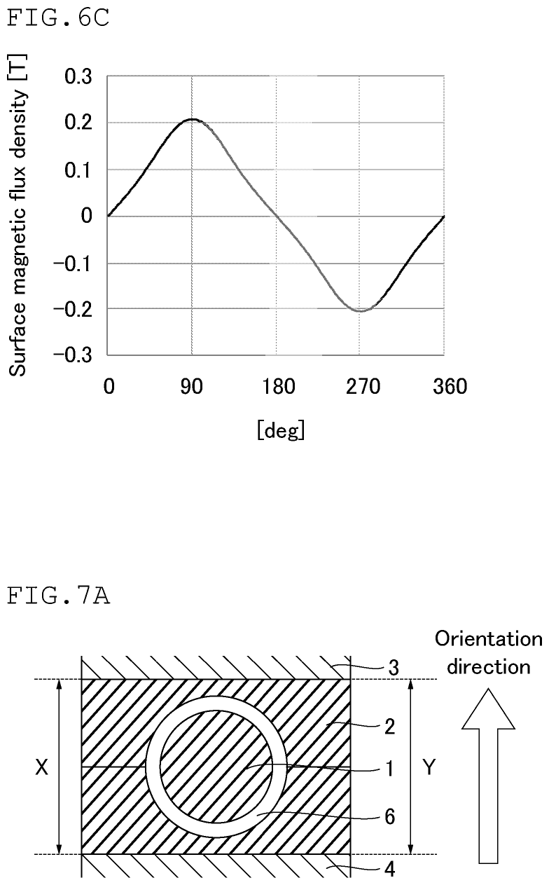

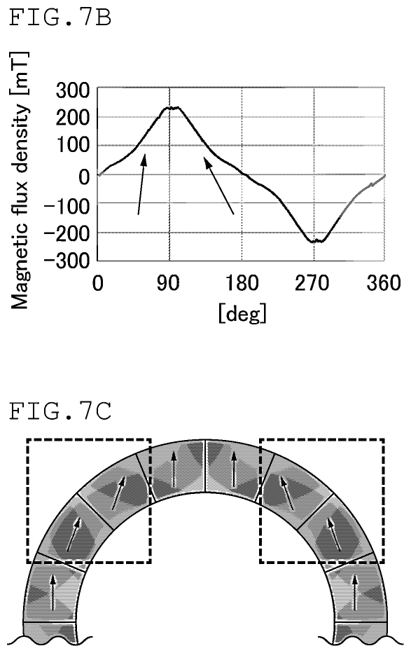

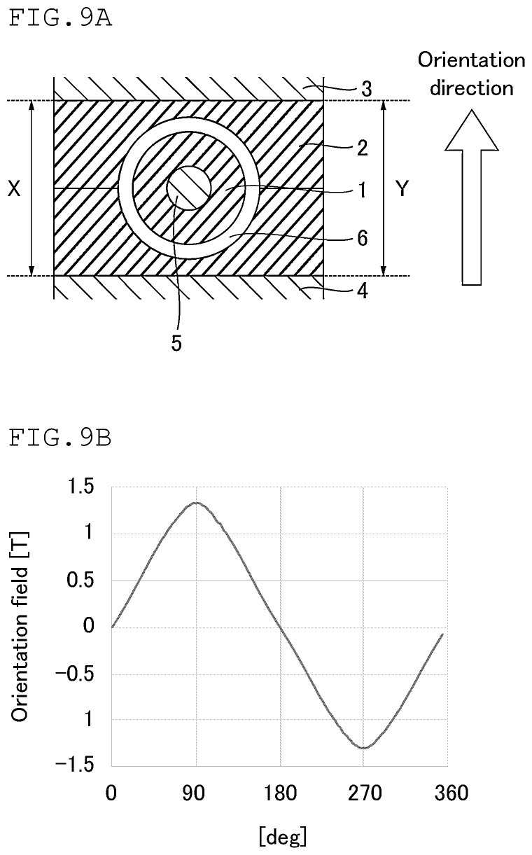

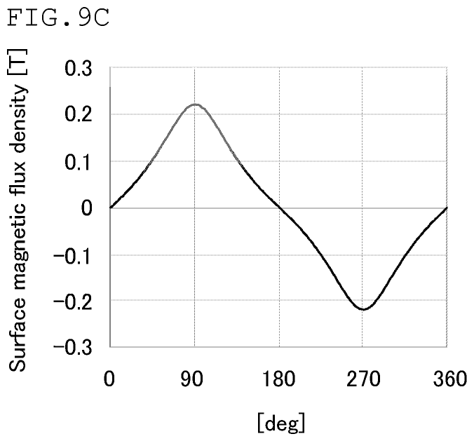

FIG. 1A shows a cross-sectional view of the mold for forming a cylindrical bonded magnet according to embodiments of the present disclosure taken in a certain direction. FIG. 3A, FIG. 4A, FIG. 5A, and FIG. 6A show cross-sectional views of forming molds according to other embodiments of the present disclosure taken in a certain direction. Moreover, FIG. 7A and FIG. 9A show cross-sectional views of molds for forming cylindrical bonded magnets as comparative examples taken in a certain direction. All the molds include an inner mold portion 1 including a non-magnetic component, an outer mold portion 2 including a non-magnetic component, a first orientation magnet 3, and a second orientation magnet 4. These molds are all given as specific examples of forming molds in which the outer mold portion 2 includes two parts which are separable in a vertical direction on paper. The outer mold portion 2 may separate and open in conjunction with the mold opening operation of a molding machine to release a molded product. FIG. 1D and FIG. 4D show cross-sectional views of the forming molds of FIG. 1A and FIG. 4A, respectively, which are open. The mold-opening direction is indicated by arrow in each of the figures. Although the outer mold portion 2 is separated into two parts in each figure, it may be separated into three or more parts or may be an inseparable integrated component.

From the results of various experiments, it is presumed that the magnetic permeability of a resin composition for a bonded magnet in a molten state is higher than the magnetic permeability of the resulting bonded magnet at room temperature. Specifically, it is believed that at the high temperatures during the bonded magnet molding at which the resin composition for a bonded magnet is melt, the orientation field is likely to pass through the center of the cylindrical bonded magnet, and the magnitude of the orientation field applied to the resin composition is different between the central portion and the outer peripheral portion of the bonded magnet. In particular, for a two-pole magnet, unlike a multipole magnet, a magnetic field is applied in one direction, and therefore it is necessary to consider changes in the magnetic permeability of the resin composition for a bonded magnet in order to impart a magnetic field with a sine waveform. In the mold according to the present embodiments, the distance X is shorter than the distance Y, so that the distance between the orientation magnets is shorter in the outer portion of the magnet than in the central portion of the magnet. The distance X is a straight line distance along the magnetic field application direction between the first orientation magnet and the second orientation magnet and is tangent to the circle defined by the inner surface of the outer mold portion. The distance Y is a straight line distance along the magnetic field application direction between the first orientation magnet and the second orientation magnet and passes through the center of the circle defined by the outer surface of the inner mold portion. As a result, the magnitude of the orientation field applied to the resin composition for a bonded magnet during molding can be uniform or nearly uniform. This enables the production of a cylindrical magnet having a sine magnetic flux density waveform or a magnetic flux density waveform close to a sine waveform.

The inner mold portion 1 includes a non-magnetic component and is located in the central portion of the mold. Examples of the non-magnetic material forming the non-magnetic component include non-magnetic steel, specifically, SUS304, HPM75, KN20, etc. The inner mold portion 1 may consist of a non-magnetic component. The inner mold portion 1 has an outer surface that forms a circle when viewed in a cross-section taken in a certain direction. Here, the certain direction refers to a magnetic field orientation direction. In view of distortion factor, the mold preferably includes a magnetic component 5 inside the inner mold portion 1. Placing the magnetic component 5 inside the inner mold portion 1 can reduce the distortion factor with respect to the sine curve of the surface magnetic flux density on the outer peripheral side. The magnetic component 5 may be formed of magnetic steel. Examples of the magnetic steel forming the magnetic component 5 include NAK80, SS400, etc.

The outer mold portion 2 includes a non-magnetic component and is spaced from the outer surface of the inner mold portion 1. The non-magnetic material forming the non-magnetic component is as described for the inner mold portion 1. The outer mold portion 2 may consist of a non-magnetic component. The outer mold portion 2 has an inner surface that forms a circle when viewed in a cross-section taken in the certain direction. A gap defined by the outer periphery of the inner mold portion 1 and the inner periphery of the outer mold portion 2 corresponds to a cavity 6. For use in the production of a bonded magnet, the cavity 6 is filled with a resin composition for the bonded magnet, which is then molded.

The first orientation magnet 3 and the second orientation magnet 4 are located to sandwich the inner mold portion 1 and the outer mold portion 2 in the certain direction. Examples of these orientation magnets include electromagnets, permanent magnets, etc. The orientation magnets are preferably electromagnets because with them it is possible to change the magnetic field and perform orientation in a larger orientation field. Here, the expression “the first orientation magnet 3 and the second orientation magnet 4 sandwich the inner mold portion 1 and the outer mold portion 2” does not necessarily mean that the orientation magnets sandwich the entire outer mold portion 2, and it is sufficient that they sandwich at least the part of the outer mold portion 2 defining the cavity. The first orientation magnet 3 and the second orientation magnet 4 sandwich the entire cavity 6. The first orientation magnet 3 and the second orientation magnet 4 sandwich the part of the outer mold portion 2 defining the cavity from one end to the other end in a direction perpendicular to the mold-opening/closing direction. In each of the molds shown in FIG. 1A, FIG. 3A, and FIG. 6A, the first orientation magnet 3 and the second orientation magnet 4 sandwich the entire outer mold portion 2. In each of the molds shown in FIG. 4A and FIG. 5A, the first orientation magnet 3 and the second orientation magnet 4 do not sandwich the entire inner mold portion 1 and the entire outer mold portion 2 but sandwich the entire part of the outer mold portion 2 defining the cavity.

When viewed in a cross-section taken in the certain direction, the distance X in a straight line in the magnetic field application direction between the first orientation magnet and the second orientation magnet tangent to the circle defined by the inner surface of the outer mold portion is shorter than the distance Y in a straight line in the magnetic field application direction between the first orientation magnet and the second orientation magnet passing through the center of the circle defined by the outer surface of the inner mold portion. In FIG. 1A, the straight line distance X and the straight line distance Y are shown with dotted lines. The expression “the straight line distance X is shorter than the straight line distance Y” means that the distance between the orientation magnets is shorter in the outer peripheral portion of the mold than in the central portion of the mold. The upper limit of the ratio of the straight line distance X to the straight line distance Y (X/Y) is preferably not higher than 0.9, more preferably not higher than 0.8. The lower limit may be at least 0.2. When the ratio of the straight line distance X to the straight line distance Y (X/Y) is within the above range, orientation even in the central portion of the cavity is facilitated during the bonded magnet molding, and it tends to be easier to obtain a bonded magnet having a sine magnetic flux density waveform or a magnetic flux density waveform close to a sine waveform.

It should be noted that, in each of the molds of comparative examples shown in FIG. 7A and FIG. 9A, the distance X in a straight line in the magnetic field application direction between the first orientation magnet and the second orientation magnet tangent to the circle defined by the inner surface of the outer mold portion is the same as the distance Y in a straight line in the magnetic field application direction between the first orientation magnet and the second orientation magnet passing through the center of the circle defined by the outer surface of the inner mold portion.

When viewed in a cross-section taken in the certain direction, the outer periphery of the outer mold portion 2 does not form a rectangle but forms a true circle or an oval, for example. The outer periphery preferably forms an oval to simultaneously achieve easy mold production and easy production of a bonded magnet having a sine magnetic flux density waveform or a magnetic flux density waveform close to a sine waveform. Moreover, the lower limit of the ratio of the semi-major axis to the semi-minor axis of the oval is preferably at least 1.1, more preferably at least 1.3. The upper limit may be not higher than 2. A ratio of the semi-major axis to the semi-minor axis of not higher than 2 leads to a sufficient orientation field. A ratio of the semi-major axis to the semi-minor axis of at least 1.1 facilitates the simultaneous achievement of easy mold production and easy production of a bonded magnet having a sine magnetic flux density waveform or a magnetic flux density waveform close to a sine waveform.

The distance Z in a straight line in the magnetic field application direction between the first orientation magnet and the second orientation magnet tangent to the circle defined by the outer surface of the outer mold portion may be zero. To achieve both mass productivity and a sine waveform, the straight line distance Z may be at least 1 mm, preferably at least 3 mm. The straight line distance Z is also preferably at least 1% but preferably not more than 80% of the straight line distance Y. The upper limit of the straight line distance Z may be not more than 50% of the straight line distance Y.

### Method of Producing Cylindrical Bonded Magnet

A method of producing a cylindrical bonded magnet according to embodiments of the present disclosure includes:
1) providing a mold including an inner mold portion including a non-magnetic component, an outer mold portion including a non-magnetic component, a first orientation magnet, and a second orientation magnet,
wherein the inner mold portion has an outer surface that forms a circle when viewed in a cross-section taken in a direction,
the outer mold portion has an inner surface that is spaced from the outer surface of the inner mold portion and forms a circle when viewed in a cross-section taken in the direction, and
the first orientation magnet and the second orientation magnet are located to sandwich the inner mold portion and the outer mold portion in the direction; and
2) performing molding to obtain a cylindrical bonded magnet by filling a region between the outer surface of the inner mold portion and the inner surface of the outer mold portion with a resin composition for a bonded magnet and molding the resin composition for a bonded magnet, while applying a magnetic field using the first orientation magnet and the second orientation magnet.

When viewed in the cross-section taken in the certain direction, a first distance is shorter than a second distance, the first distance is a straight line distance along a magnetic field application direction between the first orientation magnet and the second orientation magnet and is tangent to the circle defined by the inner surface of the outer mold portion, and the second distance is a straight line distance along the magnetic field application direction between the first orientation magnet and the second orientation magnet and passes through a center of the circle defined by the outer surface of the inner mold portion.

In the process 1) of providing a mold, the above-described mold for forming a cylindrical bonded magnet according to the embodiments of the present disclosure is provided. In the process 2) of performing molding to obtain a cylindrical bonded magnet, the mold is used to fill a region between the outer surface of the inner mold portion and the inner surface of the outer mold portion (cavity) with a resin composition for a bonded magnet and mold the resin composition for a bonded magnet. In the molding, the resin composition for a bonded magnet is oriented while applying a magnetic field using the first orientation magnet and the second orientation magnet. Examples of the molding method include injection molding.

### Resin Composition for Bonded Magnet

The resin composition for a bonded magnet used in the molding process 2) preferably contains a resin and an anisotropic rare earth magnetic powder.

### Anisotropic Rare Earth Magnetic Powder

The material of the anisotropic rare earth magnetic powder is not limited, and examples include SmFeN-based rare earth magnetic materials, NdFeB-based rare earth magnetic materials, SmCo-based rare earth magnetic materials, etc. SmFeN-based magnetic powders are preferred among these because they have heat resistance and contain no rare metal. SmFeN-based magnetic powders have a stronger magnetic force than ferrite-based magnetic powders and may be used even in a relatively small amount to generate a high magnetic force. Moreover, SmFeN-based magnetic powders have a smaller particle size than other rare earth-based magnetic powders such as NdFeB-based and SmCo-based magnetic powder and thus are suitable as fillers to be used in the base material resin. Another characteristic is that they are rust-resistant. Examples of the SmFeN-based magnetic powders include nitrides having a Th₂Zn₁₇-type crystal structure and containing the rare earth metal Sm, iron (Fe), and nitrogen (N) as represented by the general formula: SmₓFe_{100-x-y}N_{y}. In the formula, it is preferable that x is at least 8.1 atom % but not more than 10 atom %; y is at least 13.5 atom % but not more than 13.9 atom %; and the balance is mainly Fe. Examples include Sm₂Fe₁₇N₃.

The anisotropic rare earth magnetic powder used preferably has an average particle size of 10 μm or less, more preferably at least 1 μm but not more than 5 μm. When the average particle size is 10 μm or less, irregularities, cracks, etc. are less likely to occur on the surface of the product, resulting in an excellent appearance;
additionally, cost reduction can be achieved. An average particle size of more than 10 μm may lead to irregularities, cracks, etc. on the surface of the product, resulting in a poor appearance. Moreover, an average particle size of less than 1 μm can lead to a high cost of the magnetic powder, which is unfavorable in terms of cost reduction. The average particle size of the anisotropic rare earth magnetic powder is defined as the particle size corresponding to the 50th percentile of the cumulative particle size distribution by volume determined by laser diffraction. Moreover, the ratio of the 90th percentile particle size (D90) to the 10th percentile particle size (D10) in the cumulative particle size distribution by volume (D90/D10) is preferably 4.5 or less, more preferably 4 or less, particularly preferably 3.5 or less. A particle size distribution D90/D10 of 4.5 or less may lead to better fluidity during the formation of even a small thickness magnet, thus making it easier to obtain a bonded magnet having good orientation properties and a high orientation ratio.

The filling ratio of the anisotropic rare earth magnetic powder (the amount of the magnetic powder in the resin composition for a bonded magnet) is preferably at least 50 vol % but not higher than 65 vol %, more preferably at least 50 vol % but not higher than 60 vol %, still more preferably at least 50 vol % but not higher than 59 vol %, particularly preferably at least 51 vol % but not higher than 56 vol %. When the filling ratio is not higher than 65 vol %, a decrease in the magnetic flux density of the cylindrical bonded magnet having even a small thickness tends to be reduced. When the filling ratio is at least 50 vol %, the proportion of the magnetic powder in the bonded magnet can be increased to further improve the magnetic flux density.

Examples of the resin include thermoplastic resins such as polyphenylene ether, polypropylene, polyethylene, polyvinyl chloride, polyester, polyamide, polycarbonate, polyphenylene sulfide, and acrylic resins.

### Method of Producing SmFeN-Based Anisotropic Rare Earth Magnetic Powder

The SmFeN-based anisotropic rare earth magnetic powder used may be provided by purchase or other means or may be produced and provided by known methods. For example, it may be produced by a method including:
mixing a solution containing metals such as Sm and Fe with a precipitant to obtain a precipitate containing metals such as Sm and Fe (precipitation process);
firing the precipitate to obtain an oxide containing metals such as Sm and Fe (oxidation process);
heat-treating the oxide in a reducing gas-containing atmosphere to obtain a partial oxide (pretreatment process);
reducing the partial oxide (reduction process); and
nitriding alloy particles obtained in the reduction process (nitridation process).

Moreover, the method of producing a SmFeN-based anisotropic rare earth magnetic powder may be described with reference to, for example, Japanese Patent Publication No. H11-189811, WO2022/107462, etc., which are hereby incorporated by reference in their entirety.

Although the anisotropic rare earth magnetic powder produced by the above-described method may be directly used, it may be subjected to the following additional treatment:
a phosphate treatment including adding an inorganic acid to a slurry containing the anisotropic rare earth magnetic powder, water, and a phosphate compound to obtain an anisotropic rare earth magnetic powder having a surface coated with a phosphate.

### Silica Treatment Process

The anisotropic rare earth magnetic powder obtained after the phosphate treatment may optionally be subjected to a silica treatment. The formation of a silica thin film on the magnetic powder may improve oxidation resistance. The silica thin film may be formed, for example, by mixing an alkyl silicate, the phosphate-coated anisotropic rare earth magnetic powder, and an alkali solution.

### Silane Coupling Treatment Process

The magnetic powder obtained after the silica treatment may be further treated with a silane coupling agent. When the magnetic powder provided with a silica thin film is subjected to a silane coupling treatment, a coupling agent film may be formed on the silica thin film, which may improve the magnetic properties of the magnetic powder as well as wettability between the magnetic powder and the resin and magnet strength. The silane coupling agent may be selected depending on the type of the resin used. For example, silane coupling agents described in Japanese Patent Publication No. 2020-109840, which is hereby incorporated by reference in its entirety, may be appropriately used. The amount of the silane coupling agent added per 100 parts by mass of the magnetic powder is preferably at least 0.2 parts by mass but not more than 0.8 parts by mass, more preferably at least 0.25 parts by mass but not more than 0.6 parts by mass. If the amount is less than 0.2 parts by mass, the effect of the silane coupling agent tends to be small. If the amount is more than 0.8 parts by mass, the magnetic properties of the magnetic powder or magnet tend to decrease due to aggregation of the magnetic powder.

The anisotropic rare earth magnetic powder obtained after the phosphate treatment process, oxidation process, silica treatment, or silane coupling treatment may be filtered, dehydrated, and dried in a usual manner.

### Cylindrical Bonded Magnet

A cylindrical bonded magnet according to embodiments of the present disclosure includes an anisotropic rare earth magnetic powder and a resin, has two poles oriented in a radial direction, and has a distortion factor with respect to a sine curve of a surface magnetic flux density on an outer peripheral side that is not higher than 15%. The cylindrical bonded magnet according to the present embodiments is separated into two poles in the radial direction. The magnetization direction of one of the two poles of the cylindrical bonded magnet is different from that of the other pole.

The cylindrical bonded magnet according to the present embodiments may be produced by, for example, the above-described method of producing a cylindrical bonded magnet according to the embodiments of the present disclosure. Since the anisotropic rare earth magnetic powder and the resin, and the amounts thereof do not largely change before and after molding, they are as described for the resin composition for a bonded magnet. The resin is preferably a thermoplastic resin. The anisotropic rare earth magnetic powder is preferably a SmFeN-based magnetic powder. The cylindrical bonded magnet produced by the above-described method may be used after it is cut.

The distortion factor with respect to the sine curve of the surface magnetic flux density on the outer peripheral side is not higher than 15%, preferably not higher than 12%, more preferably not higher than 10%, still more preferably not higher than 8%. The distortion factor indicates the degree of distortion of the waveform. To determine the distortion factor, the surface magnetic flux density is measured using a magnet analyzer or the like, the total harmonic components (E2 to En) in the waveform of the surface magnetic flux density are calculated by Fourier transform, and then the ratio of the sum of the root-mean-square values of the total harmonic components to the root-mean-square value of the fundamental wave (E1) is calculated as the distortion factor.

Although the outer peripheral diameter of the obtained cylindrical bonded magnet is not limited, it is preferably at least 10 mm but not more than 300 mm, more preferably at least 15 mm but not more than 50 mm. Although the inner peripheral diameter is also not limited, it is preferably at least 5 mm but not more than 290 mm, more preferably at least 10 mm but not more than 45 mm. The difference between the outer peripheral diameter and the inner peripheral diameter is preferably at least 1 mm but not more than 20 mm, more preferably at least 2 mm but not more than 10 mm, still more preferably at least 2 mm but not more than 6 mm.

Although the length of the obtained cylindrical bonded magnet is not limited, it is preferably at least 1 mm but not more than 100 mm, more preferably at least 5 mm but not more than 30 mm.

### EXAMPLES

Embodiments of the present disclosure are more specifically described with reference to examples below, but they are not limited by the examples.

### Example 1

### (1-1) Production of Composition for Bonded Magnet

A SmFeN-based magnetic powder having an average particle size of 3 μm and a nylon 12 resin powder in a volume ratio of about 6:4 were mixed with a trace amount of a lubricant by a mixer, and the powder mixture was introduced into a twin screw kneader and kneaded at 210° C. to give a kneaded mixture. The kneaded mixture was cooled and cut into an appropriate size to obtain a composition for a bonded magnet.

### (1-2) Forming Mold

A mold as shown in FIG. 1A was provided. As shown in FIG. 1A, the mold includes therein an inner mold portion 1 having a magnetic component 5 at its center, an outer mold portion 2, a first orientation magnet 3, and a second orientation magnet 4. In the mold used, the distance Y between the first orientation magnet 3 and the second orientation magnet 4 is 31 mm, the distance X in a straight line in the magnetic field application direction between the first orientation magnet 3 and the second orientation magnet 4 tangent to the circle defined by the inner surface of the outer mold portion 2 is 23 mm, and the distance Z is 10 mm. Moreover, the inner mold portion 1 used is made of HPM75, and the magnetic component 5 included therein is made of NAK80. Table 1 shows the dimensions, etc. of the mold components used.

### (1-3) Injection Molding

The mold was placed in an injection molding machine. The composition for a bonded magnet was melt in a cylinder heated at 260° C. and then injection-molded into the cavity of the mold adjusted to 60° C. to obtain a cylindrical bonded magnet having an outer peripheral diameter of 29 mm, an inner peripheral diameter of 23 mm, and a height of 11 mm.

### Example 2

The production of a cylindrical bonded magnet in Example 2 was simulated under the same conditions as in Example 1, except that the inner mold portion 1 was made of SUS304 and the magnetic component 5 was made of SS400. The simulation was performed regarding the orientation field during the molding using the forming mold and the surface magnetic flux density of the cylindrical bonded magnet thus obtained.

### Example 3

The production of a cylindrical bonded magnet in Example 3 was simulated under the same conditions as in Example 2, except that a solid inner mold including no magnetic component 5 as shown in FIG. 3A was used.

### Example 4

The production of a cylindrical bonded magnet in Example 4 was simulated under the same conditions as in Example 2, except that an outer mold portion as shown in FIG. 4A was used.

### Example 5

The production of a cylindrical bonded magnet in Example 5 was simulated under the same conditions as in Example 4, except that a solid inner mold including no magnetic component 5 as shown in FIG. 5A was used.

### Example 6

The production of a cylindrical bonded magnet in Example 6 was simulated under the same conditions as in Example 2, except that a solid inner mold including no magnetic component 5 as shown in FIG. 6A and a true circle outer mold portion as shown in FIG. 6A were used.

### Comparative Example 1

A cylindrical bonded magnet was produced by the same method as in Example 1, except that a solid inner mold including no magnetic component 5 as shown in FIG. 7A and a rectangle outer mold portion in which the distance X was the same as the distance Y were used.

### Comparative Example 2

The production of a cylindrical bonded magnet in Comparative Example 2 was simulated under the same conditions as in Example 1, except that the inner mold portion 1 was made of SUS304 and the magnetic component 5 was made of SS400.

### Comparative Example 3

The production of a cylindrical bonded magnet in Comparative Example 3 was simulated under the same conditions as in Comparative Example 2, except that an inner mold including a magnetic component 5 as shown in FIG. 9A was used.

### Evaluation of Distortion Factor

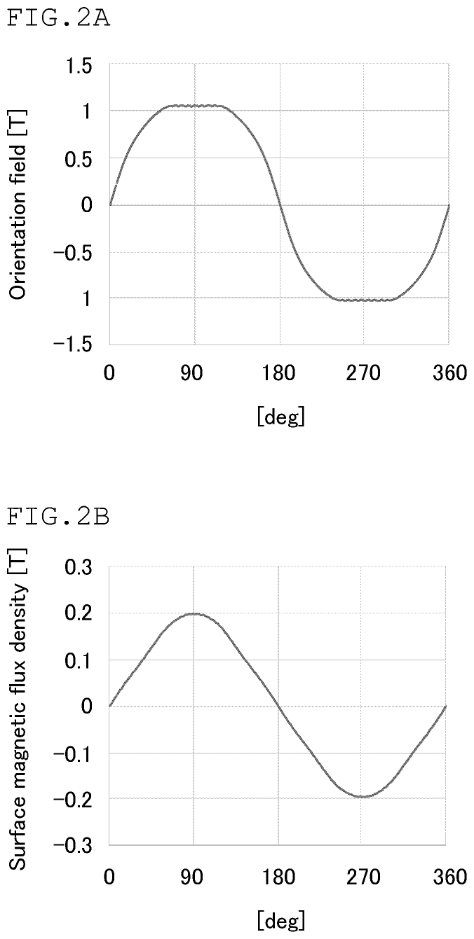

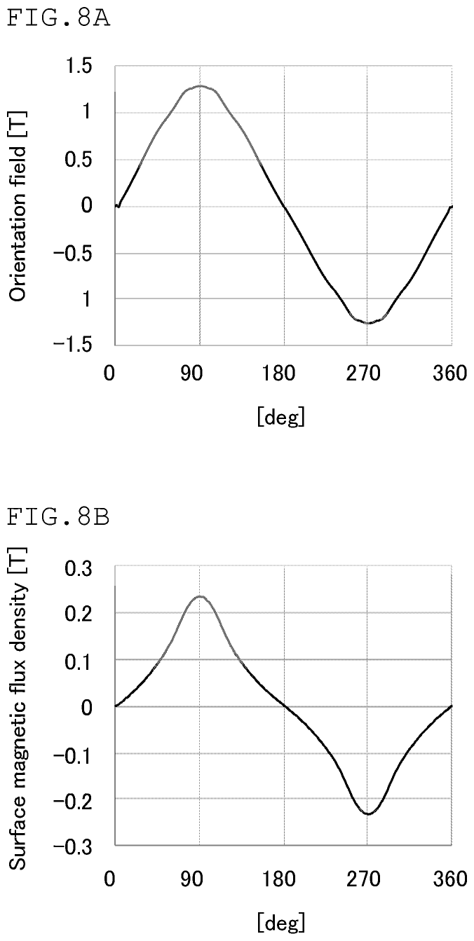

FIG. 1B and FIG. 7B show the surface magnetic flux densities of the outer peripheries of the cylindrical bonded magnets of Example 1 and Comparative Example 1, respectively, measured with a magnet analyzer. FIG. 2A, FIG. 3B, FIG. 4B, FIG. 5B, FIG. 6B, FIG. 8A, and FIG. 9B show the results of the simulations of Example 2, Example 3, Example 4, Example 5, Example 6, Comparative Example 2, and Comparative Example 3, respectively, regarding the orientation field on the surface of the outer mold portion 2 forming the outer peripheral portion of the cavity. FIG. 2B, FIG. 3C, FIG. 4C, FIG. 5C, FIG. 6C, FIG. 8B, and FIG. 9C show the results of the simulations of Example 2, Example 3, Example 4, Example 5, Example 6, Comparative Example 2, and Comparative Example 3, respectively, regarding the surface magnetic flux density of the outer periphery of the cylindrical bonded magnet. As the results in FIG. 1B are almost the same as those in FIG. 2B, the results of the actually produced product of Example 1 can be considered to be almost the same as the results of the simulated product of Example 2. As the results in FIG. 7B are almost the same as those in FIG. 8B, the results of the actually produced product of Comparative Example 1 can be considered to be almost the same as the results of the simulated product of Comparative Example 2.

FIG. 1C shows an image illustrating the magnetization directions, i.e., the directions of magnetic fluxes, in specific regions of the cylindrical bonded magnet of Example 1. FIG. 7C shows an image illustrating the magnetization directions in specific regions of the cylindrical bonded magnet of Comparative Example 1. The parts enclosed by squares correspond to the parts indicated by arrows in FIG. 7B. The results shown in FIG. 7B are considered to be due to the inclined magnetization directions in the parts enclosed by squares of the cylindrical bonded magnet of Comparative Example 1. The cylindrical bonded magnet of Example 1 achieved the results shown in FIG. 1B probably because the above issue was ameliorated.

Table 1 also shows the distortion factor with respect to the sine curve of the surface magnetic flux density on the outer periphery of each cylindrical bonded magnet. The distortion factor indicates the degree of distortion of the waveform. To determine the distortion factor, the total harmonic components (E2 to En) in the waveform were calculated by Fourier transform, and then the ratio of the sum of the root-mean-square values of the total harmonic components to the root-mean-square value of the fundamental wave (E1) was calculated as the distortion factor.

TABLE 1

| | Example | Example | Example | Example | Example | Example | Comparative | Comparative | Comparative |
|---|---|---|---|---|---|---|---|---|---|
| | 1 | 2 | 3 | 4 | 5 | 6 | Example 1 | Example 2 | Example 3 |
| Shape of outer mold | Oval | Oval | Oval | Oval | Oval | True circle | Rectangle | Rectangle | Rectangle |
| Major axis (mm) | 43 | 43 | 43 | 43 | 43 | 43 | 49 | 49 | 49 |
| Minor axis (mm) | 31 | 31 | 31 | 31 | 31 | 43 | 33 | 33 | 33 |
| Major axis/Minor | 1.39 | 1.39 | 1.39 | 1.39 | 1.39 | 1.00 | 1.48 | 1.48 | 1.48 |
| axis ratio | | | | | | | | | |
| Magnetic | Present | Present | Not present | Present | Not present | Not present | Not present | Not present | Present |
| component (mm) | 8 | 8 | | 8 | | | | | 8 |
| X (mm) | 23 | 23 | 23 | 16 | 15 | 32 | 33 | 33 | 33 |
| Y (mm) | 31 | 31 | 31 | 43 | 43 | 43 | 33 | 33 | 33 |
| Z (mm) | 10 | 10 | 10 | 15 | 5 | 0 | 33 | 33 | 33 |
| X/Y | 0.74 | 0.74 | 0.74 | 0.37 | 0.35 | 0.74 | 1.00 | 1.00 | 1.00 |
| Z/Y | 0.32 | 0.32 | 0.32 | 0.35 | 0.12 | 0.00 | 1.00 | 1.00 | 1.00 |
| Distortion factor | 7.4 | 4.7 | 9.1 | 3.8 | 9.2 | 11.8 | 22.5 | 24.4 | 17.5 |

As seen in Table 1, the distortion factors of the cylindrical bonded magnets of Examples 1 to 6 were reduced. In contrast, the distortion factors of the cylindrical bonded magnets of Comparative Examples 1 to 3 were increased.

The method of producing a bonded magnet according to the embodiments of the present disclosure enables the production of a cylindrical magnet having a sine magnetic flux density waveform or a magnetic flux density waveform close to a sine waveform. This cylindrical bonded magnet can be used in various applications such as small motors.

What is claimed is:

1. A mold for forming a cylindrical bonded magnet, comprising:
an inner mold portion including a non-magnetic component, an outer mold portion including a non-magnetic component, a first orientation magnet, and a second orientation magnet,
wherein the inner mold portion has an outer surface that forms a circle when viewed in a cross-section taken in a direction,
the outer mold portion has an inner surface that is spaced from the outer surface of the inner mold portion and forms a circle when viewed in said cross-section taken in said direction,
the first orientation magnet and the second orientation magnet are located to sandwich the inner mold portion and the outer mold portion so that a magnetic field is applied in said direction during magnetic field orientation,
when viewed in said cross-section taken in said direction, a first distance is shorter than a second distance,
wherein the first distance is a straight line distance along a magnetic field application direction between the first orientation magnet and the second orientation magnet and is tangent to the circle defined by the inner surface of the outer mold portion, and
wherein the second distance is a straight line distance along the magnetic field application direction between the first orientation magnet and the second orientation magnet and passes through a center of the circle defined by the outer surface of the inner mold portion.

2. The mold for forming a cylindrical bonded magnet according to claim 1,
wherein the outer mold portion has an outer surface that forms an oval when viewed in the cross-section taken in said direction.

3. The mold for forming a cylindrical bonded magnet according to claim 1,
wherein the mold further includes a magnetic component inside the inner mold portion.

4. The mold for forming a cylindrical bonded magnet according to claim 1,
wherein the first orientation magnet and the second orientation magnet are electromagnets.

5. A method of producing a cylindrical bonded magnet, the method comprising:
providing the mold according to claim 1; and
performing molding to obtain a cylindrical bonded magnet by filling a region between the outer surface of the inner mold portion and the inner surface of the outer mold portion with a resin composition and molding the resin composition, while applying a magnetic field using the first orientation magnet and the second orientation magnet.

6. The method of producing a cylindrical bonded magnet according to claim 5,
wherein the outer mold portion has an outer surface that forms an oval when viewed in the cross-section taken in said direction.

7. The method of producing a cylindrical bonded magnet according to claim 5,
wherein the mold further includes a magnetic component inside the inner mold portion.

8. The method of producing a cylindrical bonded magnet according to claim 5,
wherein the first orientation magnet and the second orientation magnet are electromagnets.

9. A cylindrical bonded magnet, comprising an anisotropic rare earth magnetic powder and a resin, having two poles oriented in a radial direction, and having a distortion factor with respect to a sine curve of a surface magnetic flux density on an outer peripheral side that is not higher than 15%.

10. The cylindrical bonded magnet according to claim 9,
wherein the resin is a thermoplastic resin.

11. The cylindrical bonded magnet according to claim 9,
wherein the anisotropic rare earth magnetic powder is a SmFeN-based magnetic powder.

12. The cylindrical bonded magnet according to claim 9,
wherein a difference between an outer peripheral diameter and an inner peripheral diameter of the cylindrical bonded magnet is at least 2 mm but not more than 10 mm.

13. The cylindrical bonded magnet according to claim 9,
wherein an outer peripheral diameter of the cylindrical bonded magnet is at least 15 mm but not more than 50 mm.
